(19) United States
(12) Patent Application Publication
(10) Pub. No.: US 2005/0103123 A1
(43) Pub. Date: May 19, 2005

(54) Tubular monitor systems and methods

(76) Inventor: Kenneth R. Newman, Conroe, TX (US)

Correspondence Address: Guy McClung;PMB 347, 16690 Champion Forest Drive, Spring, TX, 77379-7023, US

(21) Appl. No.: 10/713,568

(22) Filed: Nov. 14, 2003

(51) Int. Cl. G01L 1/22

(52) U.S. Cl. 73/862.045

(57) ABSTRACT

A system for measuring parameters of a structure, the system in certain aspects having a plurality of strain gauges emplaceable on the structure, signal transmission apparatus associated with the plurality of strain gauges for transmitting signals therefrom indicative of gauge measurements to computer apparatus for processing the signals, the gauges, in one aspect, including at least three strain gauge apparatuses for providing axial strain measurements, and computer apparatus for receiving signals from the transmitting apparatus indicative of the measurements and for determining bending moment and bending direction of the structure at a location of the gauge apparatuses, and in one aspect wherein the computer apparatus is programmed to calculate internal pressure and/or bending direction of the structure based on the measurements, and in one aspect to do so in real time.

### BACKGROUND OF THE INVENTION

1. Field of the Invention

The present invention is directed to tubular monitoring systems and methods.

2. Description of Related Art

There are many situations where tubulars, e.g. pipe or risers, are used both for their mechanical stiffness and their pressure containing abilities. In many of these applications, such as pipelines, pipe is basically static during its life, with fairly constant loading conditions. In other applications, such as risers and lubricators, there is dynamic movement of the pipe structure and/or variable loading conditions.

FIG. 1 illustrates a prior art well intervention system 100 using coiled tubing (“CT”), which includes a lubricator 104. The height of this system may typically be 20 to 100 ft. The CT 108 passes around a guide arch 101 and into an injector 102, down through a stripper 103, the lubricator 104, a blow out preventer (“BOP”) 105, a wellhead 106 [these items in combination sometimes referred to as a “lubricator stack”] and into a well 110. Some type of support mechanism, such as a crane block 107 is used to hold the injector 102 to prevent it from moving from side to side. Guy wires or chains 109 may also be used to provide support for the structure. These supports usually allow some side to side movement. In some offshore situations the wellhead 106 itself may be moving. The axial hanging weight of the CT, known as “weight” is typically not supported by the crane 107. Weight is supported as an axial compressive force in the lubricator 104 down to the wellhead 106. Thus various components in this structure such as the stripper 103, lubricator 104, BOP 105 and wellhead 106, serve not only as a pressure containment system, but also as load bearing structural components which must withstand the axial forces due to the weight of the CT 108 and the bending moments due to side to side movements of the structure. Similar situations exist with other drilling and intervention means such as wireline, slickline and jointed pipe.

FIG. 2 illustrates a prior art sub-sea lubricator system 200. Some type of platform, rig or vessel 201 at the sea surface 202 is being used to work on a sub-sea well 207. The sub-sea “stack” 205 is typically made up of the wellhead and a BOP and is located on the sea floor 206. A lubricator 203 is connected from the sub-sea stack 205 to a vessel 201. This lubricator 203 may contain internal pressure, must withstand the varying tension from the floating vessel 201, and must withstand the bending moments caused by sea currents 204 and/or movements of the vessel 201. A typical lubricator 203 is allowed to have some slack. The up and down movement of the vessel 201 is absorbed with decreasing and increasing slack in the lubricator. Interventions are then performed in the well from the vessel with some intervention means such as CT, wireline or jointed pipe.

FIG. 3 illustrates a prior art sub-sea riser system 300 which has some parts like that of the system 200 (and like numerals indicate like parts). The riser system 300 differs from the lubricator system 200 in that the vessel 201 has a heave motion compensation system which allows it to hold the riser 303 with a constant (or near constant) tension. No slack is permitted in the riser. A riser 303 is typically significantly larger than a lubricator 203. Lateral movements of the vessel 201 and sea currents 204 cause bending moments and varying forces in the riser 303. A riser 303 may also contain internal pressure.

The foregoing examples are only a few examples of cases where a pipe structure is loaded axially (in compression or tension) with internal pressure and with applied bending moments. These pipe structures are designed to withstand typical loading conditions without buckling or yielding. However, as various oilfield operations become more complex, the amount of loading is often unknown.

There is a need, recognized by the present inventor, for a safety system which can monitor the stresses in these various structures and various pipe based systems, especially the stresses caused by bending moments, to ensure that these systems are not approaching a critical point at which a failure may occur.

### SUMMARY OF THE PRESENT INVENTION

The present invention, in certain embodiments, teaches a system to monitor stresses in, e.g., a structure, riser, riser/lubricator, lubricator stack, pipe, tubular string, or stack structure. These stresses may be caused by the following loads:
Axial load—applied to the structure by the weights of the various components and the hanging weight (known in the industry as “weight”) of the intervention means (CT, wireline, drill pipe, etc.)
Bending moments—applied to the stack
Thermal—Temperature changes due to weather, flow of hot fluids, pumping of cold fluids, etc.
Internal pressure
External pressure (in the case of sub-sea risers or lubricators)
Torque or twist

In certain aspects, systems according to the present invention measure the strains in a section of pipe in the structure caused by one or more of these loads and stresses. Hoop strain is strain around a structure's circumference. Taken at a single point, hoop strain is the same as tangential strain. Axial strain is strain along a structure's longitudinal axis. Such systems can also measure some of the loads directly. For example, in one aspect the system measures temperature and internal pressure directly while measuring strains in the pipe to determine the other loads. Such a system may, according to the present invention, also use a weight measurement provided from another existing measurement system. To measure pressures, in one aspect a commercially available diaphragm pressure gauge apparatus is used that has one or more fiber optic strain gauges. Alternatively, commercially available electric temperature and pressure gauges are used.

In certain embodiments, the present invention teaches systems for measuring parameters of a structure, the system having: a plurality of strain gauges emplaceable on the structure; signal transmission apparatus associated with the plurality of strain gauges for transmitting signals therefrom indicative of measurements by the plurality of strain gauges to computer apparatus for processing signals from the strain gauges; the plurality of strain gauges including at least three strain gauge apparatuses for providing axial strain measurements at each location of one of the at least three strain gauge apparatuses, and computer apparatus for receiving signals from the transmitting apparatus indicative of the measurements of the at least three strain gauge apparatuses and for determining, based on said measurements, bending moment of the structure at a location of a plane including the at least three strain gauge apparatuses. In one aspect such a system the computer apparatus is programmed to calculate internal pressure of the structure based on strain measurements from the plurality of strain gauges. In one aspect of such a system, the computer apparatus is programmed to calculate bending direction of the structure at the gauges' location based on said measurements. In one aspect the computer apparatus determines bending moment in real time and, in certain aspects, does this continuously.

It is, therefore, an object of at least certain preferred embodiments of the present invention to provide:
New, useful, unique, efficient, nonobvious systems and methods for measuring parameters of a structure with a plurality of strain gauges;
Such a system and methods of use thereof which provide determinations in real time and provde, in certain aspects, a plurality of such determinations continuously; and
Such systems and methods which provide an alarm when preprogrammed maximum values are reached.

### DESCRIPTION OF THE DRAWINGS

A more particular description of embodiments of the invention briefly summarized above may be had by references to the embodiments that are shown in the drawings which form a part of this specification. These drawings illustrate certain preferred embodiments and are not to be used to improperly limit the scope of the invention that may have other equally effective or legally equivalent embodiments.

FIGS. 1-3 are side schematic views of prior art systems.

FIG. 4 is a schematic view of a system according to the present invention.

FIG. 5A is a perspective view system according to the present invention.

FIG. 5B is a perspective view of the system of FIG. 5A.

FIGS. 6 and 7 are schematic views of methods according to the present invention.

FIGS. 8A and 8B are perspective views of a system according to the present invention. FIG. 8C is an enlarged view of a valve of the system of FIG. 8A.

### DESCRIPTION OF EMBODIMENTS PREFERRED AT THE TIME OF FILING FOR THIS PATENT

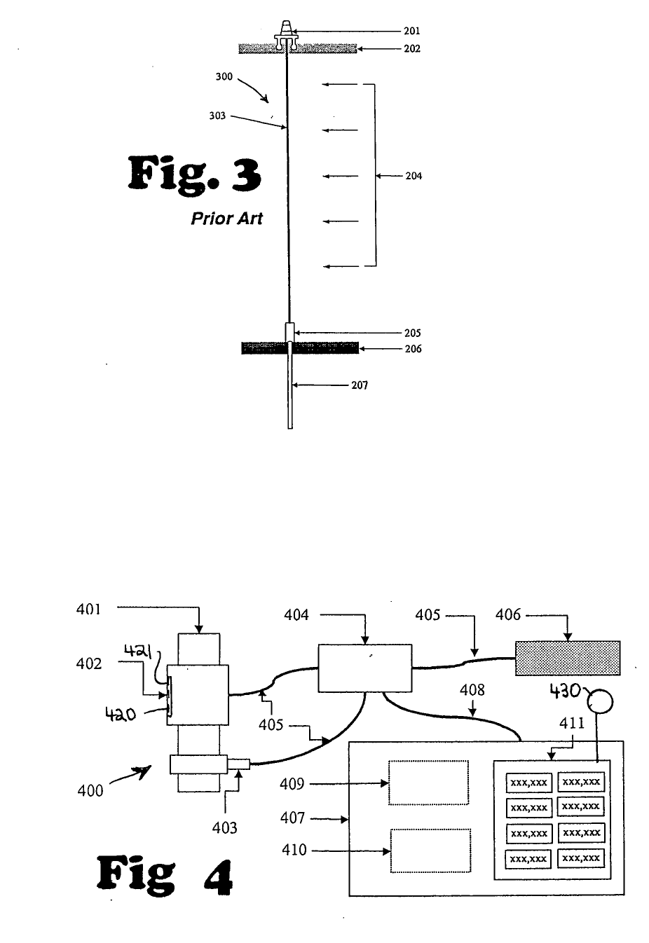

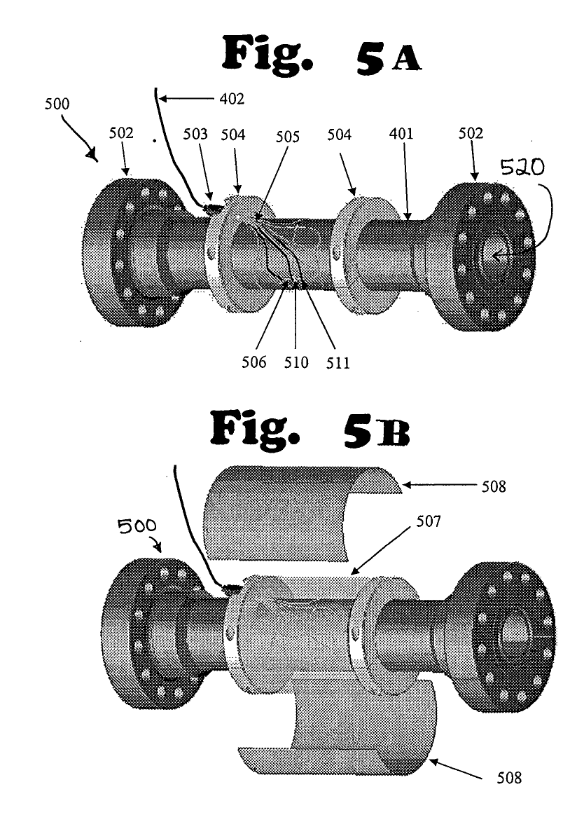

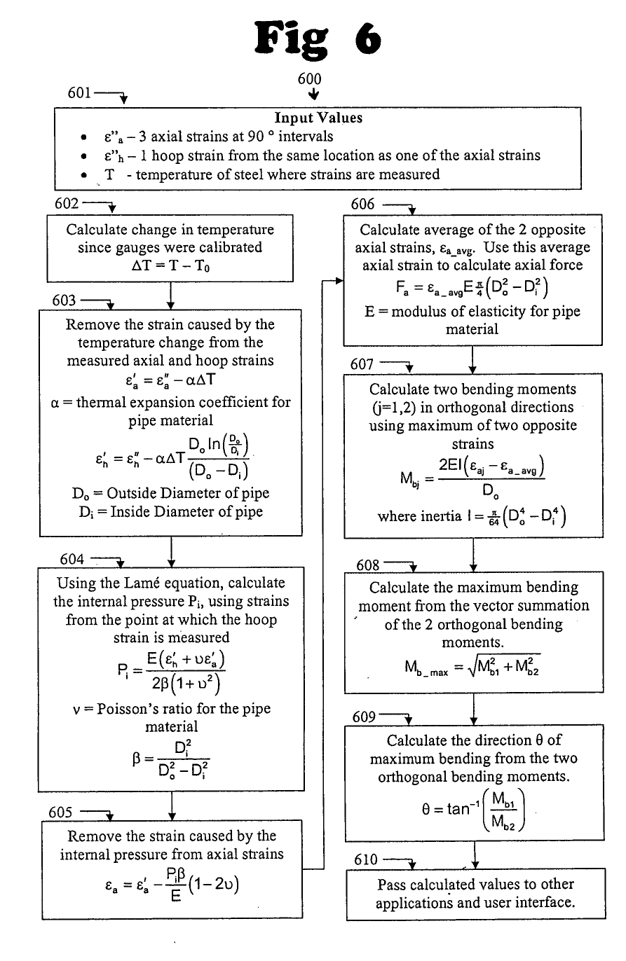

A system 400, according to the present invention as shown schematically in FIGS. 4 and 5 has a strain measuring device 402 on a section of pipe 401 which may be a section of lubricator or riser. The pipe 401 is instrumented with one or more strain gauges 420 and one or more temperature gauges 421. These gauges include signal production and signal transmission apparatus for sending signals to processing equipment, e.g. computer(s). This component of the system is referred to as the “strain measuring device” or “SMD”. There may be multiple SMDs in a system according to the present invention. It is to be understood that according to the present invention instead of a pipe 401 the system 400 (and other embodiments herein) can be used to measure parameters of a structure, e.g., but not limited to, a lubricator, a lubricator stack, a riser (surface or subsea), a tubular string, or a pipe support.

Temperature, one of the parameters measured by this device, is used to adjust the strain measurements for thermal effects. Thus this device measures strains on the pipe 401 which is a section of the pipe structure. Optionally, the system 400 has one or more pressure sensor(s) 403 to measure the internal and external pressures of the pipe 401. Optionally a weight measurement system 406 is included in the system 400. Commercially available fiber optic strain gauge temperature measuring gauges may be used which are encased in a tube (e.g., a tube made of metal, glass, or plastic) and isolated from mechanical strains so the only strains measured are those due to temperature changes.

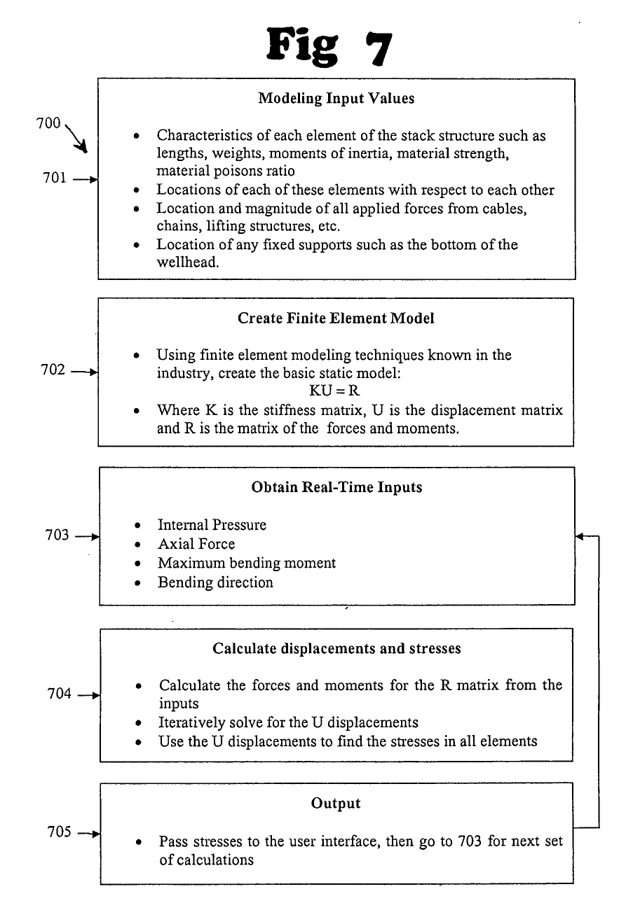

The strain, temperature, pressure and/or weight measurements are transmitted and acquired through cable(s) or other signal/data transmission apparatus 405, and, optionally, stored by a data acquisition device 404. A computer 407 or network of computers [(which may be part of the data acquisition device 404 or of separate device(s)], receives the signals indicative of the strains, temperatures and possible pressure and weight measurements from the data acquisition device 404 by signal/data transmission cable(s) or apparatus 408. A software model 409 (see also FIG. 6), run by the computer 407 appropriately programmed, uses the strains, temperatures and possible pressures and weights to calculate applied loads—axial force, bending moment, bending direction, torque and internal pressure (if not measured directly by a pressure gauge or weight measurement system).

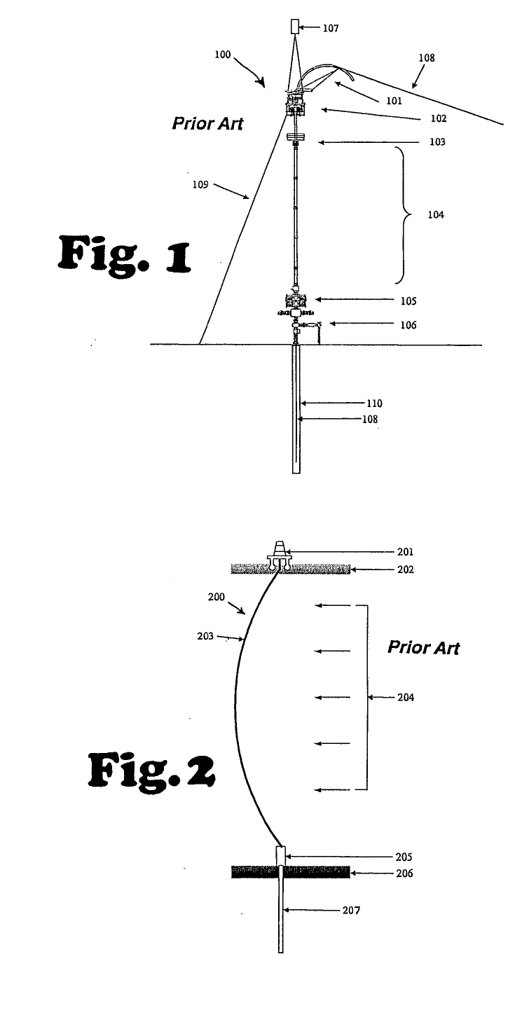

Whether the maximum stress in the stack (of which the pipe 401 is a section) occurs at the location of an SMD or elsewhere in the stack or string, a software simulation model 410 (e.g. but not limited to a model using well-known finite element analysis) uses the applied loads at the SMD (or SMDs) to calculate the stresses throughout the stack, so that a point of maximum stress can be determined. Optionally, a user interface software module 411 displays the loads from the load model 409 and/or the stresses throughout the structure from the simulation model 410 to an operator e.g. on a display apparatus 430, and, optionally, warns (audio and/or visual) the operator when the maximum stress reaches predefined safety limits. For example, an SMD 402 located at the bottom of the lubricator 104 in FIG. 1 measures the axial and hoop or tangential strains, and the temperature at this location (internal pressure in this aspect is calculated using the hoop strain values). The software model 409 converts these measured values to axial load, internal pressure and bending moment. These calculated values are displayed to the CT operator via user interface 411. Software model 410 uses the calculated values from the model 409 to model the bending of the entire structure and determine the maximum stress or stresses. The maximum stress or stresses may occur in the wellhead 106. These maximum stresses are displayed to the CT operator via the user interface 411.

FIG. 5 shows an embodiment of an SMD 500 useful in systems according to the present invention. A section of lubricator pipe 401 (like the pipe 401, FIG. 4) with flanges 502 on each end for connecting to the rest of the structure is instrumented for strain and temperature measurement. Optionally, connection to a structure through which fluid flows is made possible by a flow channel 520. A strain gauge 510 (to measure hoop or radial or tangential strains), an axial strain gauge 511, and a temperature gauge 506 are attached to the pipe 401. Many suitable types of strain and temperature measuring gauges could be used although they are not necessarily equivalent. In one particular embodiment fiber optic (“FO”) gauges are used such as those disclosed in U.S. Pat. No. 5,202,939 (fully incorporated herein for all purposes); those disclosed in the references cited in U.S. Pat. No. 5,202,939; or such as those commercially available from Roctest Telemac, Model FOS. These gauges may be attached directly to the pipe 401 as shown, or may be attached to some other member or structure which is then attached to the pipe. In one aspect, considering axial strain as a plane through a cross-section of a riser or other structure, bending moment, bending direction, and axial force are determined by determining the orientation of this plane. Three points define a plane and the minimum number of axial strain measurements required, therefore, to determine this plane is three; but, for accuracy and redundancy, in certain aspects four axial strain gauges [four measurements] are used. The axial strain plane that is determined is then used to calculate axial load, bending moment, and bending direction. In certain aspects in which a separate measurement of internal pressure is made, no hoop strain measurements are required; and, when there is no such measurement, at least one hoop strain measurement is used—at the location of the axial strain measurement—to determine the internal pressure. If, e.g., in a subsea installation, external pressure is present, it is assumed that this external pressure is known or is measured separately. In certain aspects as a check on other readings and calculations, a hoop strain measurement is done and, in such a case, there will be three gauges, like the gauges 506, 510, and 511 at one location and an axial strain gauge at another location or locations.

In one aspect three FO gauges are used (one axial, one hoop, and one temperature) and are attached to the pipe 401 at approximately the same location; and, in one aspect, four such sets of gauges are spaced at 90 degree intervals around the circumference of the pipe. The type and number of gauges at each location may vary. In one aspect, three axial strain measurements are made at three locations to calculate the loading on a structure [e.g., but not limited to, a subsea structure, a pipe support structure, a riser, a subsea riser, a lubricator, a lubricator stack, a tubular (riser, pipe) string]. In one aspect one hoop strain measurement is used to calculate loading on a structure if the internal and/or external pressures are not known. In certain aspects only one temperature measurement is needed if the temperature is uniform around the circumference of the pipe 401. In another aspect, internal pressure is measured by a pressure gauge. If the weight is known, two axial strain measurements will suffice if they are not one hundred eighty degrees apart.

The FO gauges (from all locations) are connected by FO cables 505 to a FO connector 503, located on a protector ring 504. A FO cable 509 is run from the FO connector 503 to a data acquisition system (e.g. to a data acquisition device 404 of a system 400 as described above).

The cylindrical volume between the protector rings 504 is, optionally, filled with a supporting material 507 (e.g. potting material) (as shown in FIG. 5B) to protect the FO gauges and cables 505. The entire SMD 500 is then, optionally, covered with covers 508 [made, e.g. of metal (e.g. steel, stainless steel, bronze, zinc, aluminum, and/or alloys thereof or plastic)] for further protection. The SMD 500 is placed in the structure at a position such as between a lubricator 104 and a BOP 105, or between a BOP 105 and a wellhead 106 (see FIG. 1).

The data acquisition device 404 is capable of acquiring data from FO strain gauges and, optionally, data from pressure sensors 403. It will also accept weight measurements if available from existing weight measurement systems 406. It then makes this data available to the software model 409.

The software model 409 shown in more detail in a method 600 in FIG. 6 is a load conversion model. There are various well-known equations and calculation methods which could be used for such a model, e.g. to convert the strain, temperature and possible weight and pressure measurements into calculated axial force, bending moment and bending direction at the location of the gauges, applied torque, internal and external pressure values. Another analysis (e.g. an FEM analysis as described herein) calculates bending moment and bending direction throughout an entire structure. FIG. 6 provides one example of equations used by the software model to calculate for a structure the internal pressure, axial force, bending moment and bending direction. FIG. 6 shows an example of one such model 600 in which the applied weight and internal pressure are not known, and in which there is no applied torque or external pressure. (Alternatively, internal pressure is an input value and hoop strain is not required.) The inputs (601) are the temperature T and four axial strains from four FO strain gauges located at 90° intervals around the pipe [one hoop strain measured at the same location as one of the axial strains], although as noted already three strain gauges may be used.

The gauges are calibrated. The difference between the current temperature and the temperature at the time of calibration is calculated (602). The strain caused by this temperature difference is then subtracted from the strain measurement (603). The internal pressure is calculated from the temperature corrected hoop strains and axial strain at one location (604). (In the alternate version in which the internal pressure is measured, the step 604 is deleted.) The axial strain caused by the internal pressure is then subtracted from the temperature corrected axial strains (605). The axial strains corrected for temperature and internal pressure are used to calculate the axial force (606). Two orthogonal bending moments are calculated using the same axial strains (607). These orthogonal bending moments are then used to calculate the maximum bending moment (608) and the direction of bending (609). Finally, the calculated internal pressure, axial force, maximum bending moment and bending direction are passed (610) to the user interface 411 and other applications such as the stack simulation model 410.

FIG. 7 shows a flowchart 700 of one aspect of a stack simulation model 410. Characteristics and geometry of the stack structure are inputs (701) used to create a finite element model (“FEM”) of the structure 702. Once the FEM is created, the model is ready for real-time analysis. Real time inputs 703 are obtained from the load conversion model (see model 409 and FIG. 6). These inputs are used in the FEM to solve for the displacements and stresses in the structure (704). These displacement and stress values are passed (705) to the user interface 411. These values are calculated repeatedly in real-time, to give a continuous indication of the integrity of the stack structure.

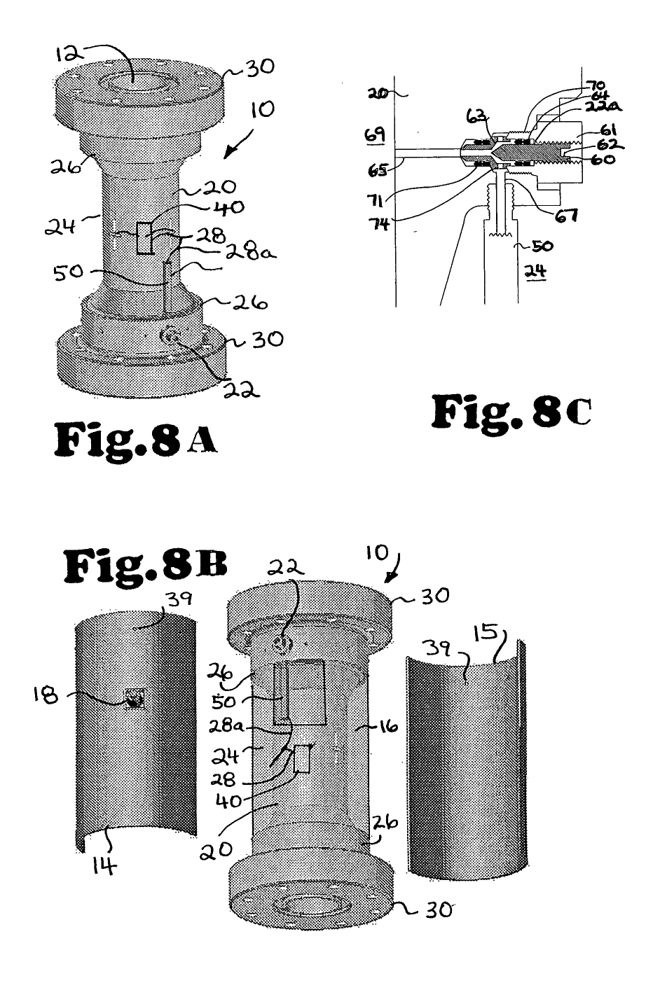

FIGS. 8A and 8B illustrate a system 10 according to the present invention which has a main body 20 with end flanges 30 for connecting the system 10 to a structure (optionally with a central channel 12 that extends from one end of the body 20 to the other for use with hollow structures through which fluid flows). Optional selectively removable covers 14, 15 held in place by fasteners 39, screws, bolts, and/or adhesives protect an inner space 24 between two inner rings 26 on the body 20. Strain gauge apparatus 40 (shown schematically) is positioned on the surface of the body 20 and may be any such apparatus disclosed herein with any strain gauge, temperature gauge, pressure gauge, or gauge combination disclosed herein. Cables 28 (shown schematically; like the cables 505) are connected to a connector 18 (like the connector 503).

An internal pressure gauge 50 which, in one aspect, is a commercially available fiber optic pressure gauge apparatus with associated signal generation apparatus and associated signal transmission apparatus, is disposed in the space 24 and a cable 28a runs from it to the connector 18 to transmit signals to computer apparatus. The strain gauge apparatus 40 is, optionally encased in protective material, e.g., potting material 16, but the internal pressure gauge 50, in one aspect, is not (although it may be according to the present invention). A valve 22 is selectively closable to prevent undesirable fluid, including, but not limited to wellbore fluids, from entering into the space 24; e.g., but not limited to, in a situation in which the internal pressure gauge is damaged or is broken off to isolate the internal space and/or strain gauges from such fluid.

In one aspect, shown in FIG. 8C, the valve 22 is an allen-wrench-operable needle valve 22a. A movable valve member 60 with an allen wrench receptacle 62 is threadedly and movably disposed in a nut 61 which is threadedly mounted in a channel 70 of the body 20. Seals 64 seal an interface between the valve member 60 and the nut 61. Upon movement of the valve member 60 to abut a valve seat 63, fluid flow into the space 24 from an interior 69 of the body 20 is prevented. The space 24 is in fluid communication with the space 69 via channels 65 and 67 in the body 20 and channel 74 in the valve seat 63. The internal pressure gauge 50 is threadedly connected to the body 20. Seals 71 seal the body-20/valve-seat 63 interface.

In certain particular aspects, the internal pressure gauge is a commercially available Roctest Telemac Fiber-Optic Piezometer FOP Series from Roctest Limited. Also for any embodiment herein a commercially available Roctest Telemac fiber optic Temperature Sensor gauge Models FOT-F and FOT-N from Roctest Limited may be used; and in other apsects a sensor as disclosed in U.S. Pat. No. 5,870,511 may be used.

The present invention, therefore, provides in at least some, but not necessarily all, of its embodiments a system for measuring parameters of a structure (hollow or solid), the system including: a plurality of strain gauges emplaceable on the structure; signal transmission apparatus associated with the plurality of strain gauges for transmitting signals therefrom indicative of measurements by the plurality of strain gauges to computer apparatus for processing signals from the strain gauges; the plurality of strain gauges including at least three strain gauge apparatuses for providing axial strain measurements at each location of one of the at least three strain gauge apparatuses: and computer apparatus for receiving signals from the transmitting apparatus indicative of the measurements of the at least three strain gauge apparatuses and for determining, based on said measurements, bending moment of the structure at a location of a plane including the at least three strain gauge apparatuses. Such a system may have one or some, in any possible combination, of the following: wherein the computer apparatus is programmed to calculate internal pressure of the structure based on strain measurements from the plurality of strain gauges; wherein the computer apparatus is programmed to calculate bending direction of the structure at said location based on said measurements; wherein the computer apparatus determines bending moment in real time; wherein the computer apparatus is programmed to make a plurality of continuous determinations of bending moment and/or other parameters in real time; encasement material encasing the plurality of strain gauges; wherein the encasement material is insulating material for enhancing uniformity of operation of the plurality of strain gauges during temperature changes; wherein the encasement material is potting material; each, some or all of the plurality of strain gauges is/are fiber optic strain gauge(s); display apparatus for displaying to an operator determinations and/or caclulations of the computer apparatus; alarm apparatus (audio and/or visual) for warning an operator of the system that a maximum allowable stress on the structure has been reached, the computer apparatus programmed to calculate maximum allowable stress and in communication with the alarm apparatus; temperature measurement apparatus for measuring temperature of the structure at the location of plurality of strain gauges; wherein the temperature measurement apparatus is fiber optic strain gauge apparatus for measuring temperature; wherein the computer apparatus is programmed to adjust measurements for temperature changes indicated by the temperature measurement apparatus; wherein the system includes temperature measurement apparatus for measuring temperature of the structure at the location of the plurality of strain gauges, pressure measurement apparatus for measuring internal pressure of the structure, and weight measurement apparatus for measuring weight of the structure, and the computer apparatus is programmed to receive signals indicative of strain measurements from the plurality of strain gauges, temperature measurements from the temperature measurement apparatus, internal pressure measurements from the pressure measurement apparatus, and weight measurement from the weight measurement apparatus, and the computer apparatus is programmed to determine bending moment of the structure at the location of the plurality of strain gauges, stresses throughout the structure, maximum stress on the structure, and location of maximum stress on the structure; wherein the plurality of strain gauges comprises at least one set of three fiber optic strain gauges including an axial strain gauge for measuring axial stress on the structure, a hoop strain gauge for measuring hoop stress on the structure, and a temperature strain gauge for measuring temperature of the structure; wherein the at least one set of three fiber optic strain gauges is four sets spaced at ninety 90 degree intervals around the structure; wherein the structure is from the group consisting of riser, subsea riser, lubricator, pipe support structure, tubular string, pipe, and lubricator stack; protective ring apparatus on the structure adjacent which is located the plurality of strain gauges; wherein the protective ring apparatus is two spaced-apart rings between which are located the plurality of strain gauges; wherein potting material encapsulates the plurality of strain gauges; and/or cover apparatus releasably connected to the structure over the plurality of strain gauges.

The present invention, therefore, provides in at least some, but not necessarily all, of its embodiments a method for measuring parameters of a structure, the method including measuring parameters of the structure with a system such as any according to the present invention disclosed, described, and/or claimed herein. Such a system may have one or some, in any possible combination, of the following using suitable systems as disclosed herein: with the computer apparatus, calculating internal pressure; with the computer apparatus, calculating bending direction; with the computer apparatus, determining bending moment and/or other parameter or parameters in real time; with the computer apparatus, making a plurality of continuous determinations in real time; with the computer apparatus, calculating in real time bending direction, bending moment, stresses throughout the structure, maximum stress, location of maximum stress; and/or displaying determiend and/or calculated parameters on display apparatus.

All patents referred to herein by number are incorporated fully herein for all purposes. In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to all equivalent elements or steps. The following claims are intended to cover the invention as broadly as legally possible in whatever form it may be utilized. The invention claimed herein is new and novel in accordance with 35 U.S.C. § 102 and satisfies the conditions for patentability in § 102. The invention claimed herein is not obvious in accordance with 35 U.S.C. § 103 and satisfies the conditions for patentability in § 103. This specification and the claims that follow are in accordance with all of the requirements of 35 U.S.C. § 112. The inventors may rely on the Doctrine of Equivalents to determine and assess the scope of their invention and of the claims that follow as they may pertain to apparatus not materially departing from, but outside of, the literal scope of the invention as set forth in the following claims.

1-29. (canceled)

30. A system for measuring parameters of a structure, the system comprising
a plurality of strain gauges emplaceable on the structure,
signal transmission apparatus associated with the plurality of strain gauges for transmitting signals therefrom indicative of measurements by the plurality of strain gauges to computer apparatus for processing signals from the strain gauges,
the plurality of strain gauges including at least three strain gauge apparatuses for providing axial strain measurements at each location of one of the at least three strain gauge apparatuses,
computer apparatus for receiving signals from the transmitting apparatus indicative of the measurements of the at least three strain gauge apparatuses and for determining, based on said measurements, bending moment of the structure at a location of a plane including the at least three strain gauge apparatuses,
temperature measurement apparatus for measuring temperature of the structure at the location of the plurality of strain gauges, and
wherein the computer apparatus is programmed to adjust said measurements for temperature changes indicated by the temperature measurement apparatus.

31. The system of claim 30 wherein the computer apparatus is programmed to calculate internal pressure of the structure based on strain measurements from the plurality of strain gauges.

32. The system of claim 30 wherein the computer apparatus is programmed to calculate bending direction of the structure at said location based on said measurements.

33. The system of claim 31 wherein the computer apparatus determines bending moment in real time.

34. The system of claim 33 wherein the computer apparatus is programmed to make a plurality of continuous determinations of bending moment in real time.

35. The system of claim 31 further comprising encasement material encasing the plurality of strain gauges.

36. The system of claim 35 wherein the encasement material comprises insulating material for enhancing uniformity of operation of the plurality of strain gauges during temperature changes.

37. The system of claim 35 wherein the encasement material comprises potting material.

38. The system of claim 30 further comprising
each of the plurality of strain gauges comprises a fiber optic strain gauge.

39. The system of claim 30 further comprising
display apparatus for displaying to an operator determinations of the computer apparatus.

40. The system of claim 30 further comprising
alarm apparatus for warning an operator of the system that a maximum allowable stress on the structure has been reached, the computer apparatus programmed to calculate maximum allowable stress and in communication with the alarm apparatus.

41. The system of claim 30 wherein the temperature measurement apparatus comprises fiber optic strain gauge apparatus for measuring temperature.

42. The system of claim 30 wherein the system includes temperature measurement apparatus for measuring temperature of the structure at the location of the plurality of strain gauges, pressure measurement apparatus for measuring internal pressure of the structure, and weight measurement apparatus for measuring weight of the structure; and the computer apparatus is programmed to receive signals indicative of strain measurements from the plurality of strain gauges, temperature measurements from the temperature measurement apparatus, internal pressure measurements from the pressure measurement apparatus, and weight measurement from the weight measurement apparatus, and the computer apparatus is programmed to determine bending moment of the structure at the location of the plurality of strain gauges, stresses throughout the structure, maximum stress on the structure, and location of maximum stress on the structure.

43. The system of claim 30 wherein the plurality of strain gauges comprises at least one set of three fiber optic strain gauges including an axial strain gauge for measuring axial stress on the structure, a hoop strain gauge for measuring hoop stress on the structure, and a temperature strain gauge for measuring temperature of the structure.

44. The system of claim 43 wherein the at least one set of three fiber optic strain gauges is four sets spaced at ninety 90 degree intervals around the structure.

45. The system of claim 30 wherein the structure is from the group consisting of riser, subsea riser, lubricator, pipe support structure, tubular string, and lubricator stack.

46. The system of claim 30 further comprising
a protective ring apparatus on the structure adjacent which is located the plurality of strain gauges.

47. The system of claim 46 wherein the protective ring apparatus is two spaced-apart rings between which are located the plurality of strain gauges.

48. The system of claim 46 wherein potting material encapsulates the plurality of strain gauges.

49. The system of claim 30 further comprising
cover apparatus releasably connected to the structure over the plurality of strain gauges.

50. A method for measuring parameters of a structure, the method comprising
measuring parameters of the structure with a system, the system comprising a plurality of strain gauges emplaceable on the structure, signal transmission apparatus associated with the plurality of strain gauges for transmitting signals therefrom indicative of measurements by the plurality of strain gauges to computer apparatus for processing signals from the strain gauges, the plurality of strain gauges including at least three strain gauge apparatuses for providing axial strain measurements at each location of one of the at least three strain gauge apparatuses, computer apparatus for receiving signals from the transmitting apparatus indicative of the measurements of the at least three strain gauge apparatuses and for determining, based on said measurements, bending moment of the structure at a location of a plane including the at least three strain gauge apparatuses, temperature measurement apparatus for measuring temperature of the structure at the location of the plurality of strain gauges, and wherein the computer apparatus is programmed to adjust said measurements for temperature changes indicated by the temperature measurement apparatus, and the computer apparatus is programmed to receive signals indicative of temperature measurements from the temperature measurement apparatus.

51. The method of claim 51 wherein the computer apparatus is programmed to calculate internal pressure of the structure based on strain measurements from the plurality of strain gauges, the method further comprising
with the computer apparatus, calculating said internal pressure.

52. The method of claim 51 wherein the computer apparatus is programmed to calculate bending direction of the structure at said location based on said measurements, the method further comprising
with the computer apparatus, calculating said bending direction.

53. The method of claim 51 wherein the computer apparatus determines bending moment in real time, the method further comprising
with the computer apparatus, determining said bending moment in real time.

54. The system of claim 51 wherein the computer apparatus is programmed to make a plurality of continuous determinations of bending moment in real time, the method further comprising
with the computer apparatus, making said plurality of continuous determinations in real time.

55. The method of claim 51 wherein the computer apparatus is programmed to calculate bending direction of the structure at said location based on said measurements and wherein the system includes pressure measurement apparatus for measuring internal pressure of the structure, and weight measurement apparatus for measuring weight of the structure; and the computer apparatus is programmed to receive signals indicative of strain measurements from the plurality of strain gauges, internal pressure measurements from the pressure measurement apparatus, and weight measurement from the weight measurement apparatus, and the computer apparatus is programmed to determine, in real time, bending moment of the structure at the location of the plurality of strain gauges, stresses throughout the structure, maximum stress on the structure, and location of maximum stress on the structure, the method further comprising
with the computer apparatus, calculating in real time said bending direction, said bending moment, said stresses throughout the structure, said maximum stress, and said location of said maximum stress.

56. The method of claim 51 wherein the said bending direction, said bending moment, said stresses throughout the structure, said maximum stress, and said location of said maximum stress are displayed on display apparatus.

57. A system for measuring parameters of a structure, the system comprising
a plurality of strain gauges emplaceable on the structure,
signal transmission apparatus associated with the plurality of strain gauges for transmitting signals therefrom indicative of measurements by the plurality of strain gauges to computer apparatus for processing signals from the strain gauges,
the plurality of strain gauges including at least three strain gauge apparatuses for providing axial strain measurements at each location of one of the at least three strain gauge apparatuses,
computer apparatus for receiving signals from the transmitting apparatus indicative of the measurements of the at least three strain gauge apparatuses and for determining, based on said measurements, bending moment of the structure at a location of a plane including the at least three strain gauge apparatuses,
temperature measurement apparatus for measuring temperature of the structure at the location of the plurality of strain gauges,
wherein the system includes pressure measurement apparatus for measuring internal pressure of the structure, and weight measurement apparatus for measuring weight of the structure; and the computer apparatus is programmed to receive signals indicative of strain measurements from the plurality of strain gauges, temperature measurements from the temperature measurement apparatus, internal pressure measurements from the pressure measurement apparatus, and weight measurement from the weight measurement apparatus, and the computer apparatus is programmed to determine bending moment of the structure at the location of the plurality of strain gauges, stresses throughout the structure, maximum stress on the structure, and location of maximum stress on the structure.

58. A system for measuring parameters of a structure, the system comprising
a plurality of strain gauges emplaceable on the structure,
signal transmission apparatus associated with the plurality of strain gauges for transmitting signals therefrom indicative of measurements by the plurality of strain gauges to computer apparatus for processing signals from the strain gauges,
the plurality of strain gauges including at least three strain gauge apparatuses for providing axial strain measurements at each location of one of the at least three strain gauge apparatuses,
computer apparatus for receiving signals from the transmitting apparatus indicative of the measurements of the at least three strain gauge apparatuses and for determining, based on said measurements, bending moment of the structure at a location of a plane including the at least three strain gauge apparatuses,
a protective ring apparatus on the structure adjacent which is located the plurality of strain gauges, and
wherein the protective ring apparatus is two spaced-apart rings between which are located the plurality of strain gauges.

59. A method for measuring parameters of a structure, the method comprising
measuring parameters of the structure with a system, the system comprising a plurality of strain gauges emplaceable on the structure, signal transmission apparatus associated with the plurality of strain gauges for transmitting signals therefrom indicative of strain measurements by the plurality of strain gauges to computer apparatus for processing signals from the strain gauges, the plurality of strain gauges including at least three strain gauge apparatuses for providing axial strain measurements at each location of one of the at least three strain gauge apparatuses, and computer apparatus for receiving signals from the transmitting apparatus indicative of the measurements of the at least three strain gauge apparatuses and for determining, based on said measurements, bending moment of the structure at a location of a plane including the at least three strain gauge apparatuses,
wherein the computer apparatus is programmed to calculate bending direction of the structure at said location based on said measurements and wherein the system includes temperature measurement apparatus for measuring temperature of the structure at the location of the plurality of strain gauges, pressure measurement apparatus for measuring internal pressure of the structure, and weight measurement apparatus for measuring weight of the structure; and the computer apparatus is programmed to receive signals indicative of strain measurements from the plurality of strain gauges, temperature measurements from the temperature measurement apparatus, internal pressure measurements from the pressure measurement apparatus, and weight measurement from the weight measurement apparatus, and the computer apparatus is programmed to determine, in real time, bending moment of the structure at the location of the plurality of strain gauges, stresses throughout the structure, maximum stress on the structure, and location of maximum stress on the structure, the method further comprising
with the computer apparatus, calculating in real time said bending direction, said bending moment, said stresses throughout the structure, said maximum stress, and said location of said maximum stress.

60. The method of claim 59 wherein the said bending direction, said bending moment, said stresses throughout the structure, said maximum stress, and said location of said maximum stress are displayed on display apparatus.
